(19) United States
(12) Patent Application Publication
(10) Pub. No.: US 2009/0010170 A1
(43) Pub. Date: Jan. 8, 2009

(54) Varying the Position of Test Information in Data Units

(76) Inventors: Gerald Pepper, Calabasas, CA (US); Doug Schafer, Agoura Hills, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/212,531

(22) Filed: Sep. 17, 2008

Related U.S. Application Data
(63) Continuation of application No. 11/284,622, filed on Nov. 21, 2005.

(51) Int. Cl. H04L 12/26

(52) U.S. Cl. 370/241

(57) ABSTRACT

Variable positioning of test information in data units is disclosed. A method of preparing data units with test information located in varying locations is disclosed. The test information includes a signature. A method of receiving data units having test information in varying locations is disclosed. Upon receipt, the test information is located based on a signature included with the test information. The test information may be located in data units between a header at the beginning of the data unit and a frame check sequence field at the end of the data unit. The location of the test information may vary between data units in different flows, and between data units in different streams. The methods may be achieved in a network communications unit included in, for example, a network card, a network testing system and a computer.

### RELATED APPLICATION INFORMATION

This patent claims priority from U.S. application Ser. No. 11/284,622 filed Nov. 21, 2005, now U.S. Pat. No. XXX.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The invention relates to network communications, data units, and the transmission of and receipt of network traffic.

2. Related Art

Networks such as the Internet carry a variety of data communicated using a variety of network devices including servers, routers, hubs, switches, and other devices. Before placing a network into use, the network, including the network devices, network media, network segments and network applications included therein, may be tested to ensure successful operation. Network devices and applications may be tested, for example, to ensure that they function as intended, comply with supported protocols, and can withstand anticipated traffic demands. Such testing may also be performed on already deployed network devices, network segments and network applications.

To assist with the construction, installation and maintenance of networks, network applications and network devices, networks may be augmented with network analyzing devices, network conformance systems, network monitoring devices, and network traffic generators, all which are referred to herein as network testing systems. The network testing systems may allow for analyzing the performance of networks, network applications and network devices by capturing, modifying, analyzing and/or sending network communications.

Network testing systems send and receive a large amount of network traffic and establish and end many communication sessions. Network interface devices, units, cards, chips and the like perform much of the work in sending and receiving network traffic and establishing and ending sessions. To track network communications sent and received by network testing systems so that network devices may be tested, network communications are prepared with test information. The functioning of a device under test may be evaluated based on review of the test information included in network communications.

### DESCRIPTION OF THE DRAWINGS

FIG. 1 is a block diagram of an environment in which data units having test information located in varying positions may be sent and/or received by a network card in a network testing system.

FIG. 2 is a block diagram of an environment in which data units having test information located in varying positions may be sent and/or received by a network interface included in a computer.

FIG. 3 is a block diagram of a network card in which data units having test information located in varying positions may be sent and/or received.

FIGS. 4A and 4B are block diagrams of a data unit having test information located in varying positions.

FIG. 5 is a block diagram of data units having test information located in varying positions.

FIG. 6 is a flow chart of a method performed when preparing to send data units having test information located in varying positions.

FIG. 7 is a flow chart of a method performed when receiving data units having test information located in varying positions.

### DETAILED DESCRIPTION OF THE INVENTION

Throughout this description, the embodiments and examples shown should be considered as exemplars, rather than limitations on the devices and methods described.

Device and Systems

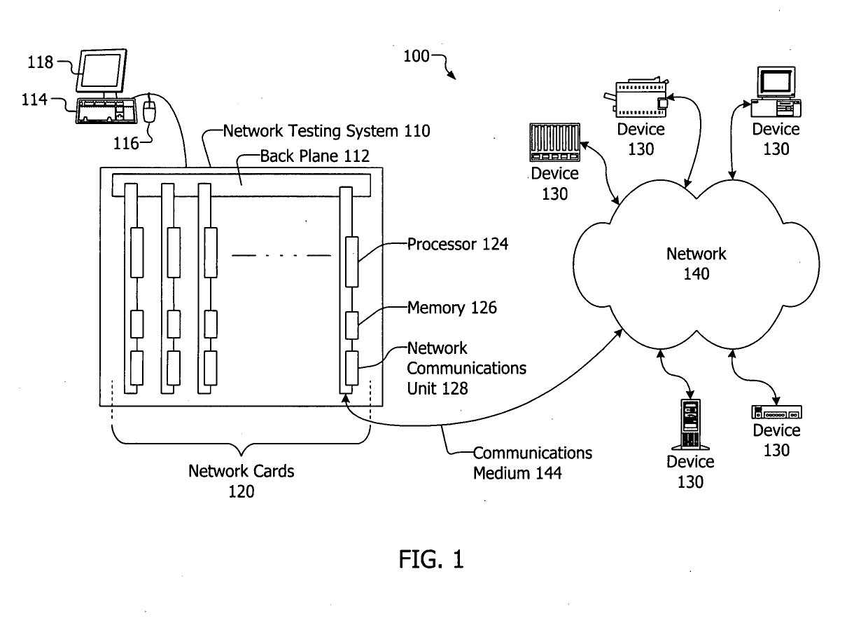

FIG. 1 is a block diagram of an environment 100 in which data units having test information located in varying positions may be sent and/or received by a network card 120 in a network testing system 110. The environment 100 includes network testing system 110 coupled via a network card 120 to a network 140 over a communications medium 144. The network testing system 110 may include or be one or more of a performance analyzer, a conformance validation system, a network analyzer, a packet blaster, a network management system, a combination of these, and/or others. The network testing system 110 may be used to evaluate the performance of servers, networking devices such as, for example, routers, bridges, gateways, load sharers, load balancers and others, as well as network applications and other software. The network testing system 110 may be used to evaluate or measure characteristics and performance of a communication line or system, including the throughput of network traffic, the number of dropped packets, jitter, and other characteristics and performance. Such testing may be used to evaluate the Mean Opinion Score (MOS) of voice transmission over a network or portion thereof. That is, the network testing system 110 may be used to test and evaluate the network 140 and/or portions thereof, network capable devices 130 (defined below), applications running on network capable devices 130, and/or services provided by network 140 and/or network capable devices 130.

The network testing system 110 may be in the form of a chassis or card rack, as shown in FIG. 1, or may be an integrated unit. Alternatively, the network testing system may comprise a number of separate units such as two or more chassis cooperating to provide network analysis, network conformance testing, and other tasks. The chassis of the network testing system 110 may include one or more network cards 120 and a back plane 112. The network cards 120 may be coupled with back plane 112. One or more network cards 120 may be included in network testing system 110. The network cards 120 may be permanently installed in the network testing system 110, may be removable, or may be a combination thereof.

The network testing system 110 and/or one or more of the network cards 120 may include an operating system such as, for example, versions of Linux, Unix and Microsoft Windows.

At least one network card 120 is coupled with network 140 via a communications medium 144. Although only one connection over communications medium 144 is shown, each of the network cards 120 may be connected with network 140 over a communications medium. In addition, in some embodiments, each network card may have two or more connections with network 140 or two or more networks. The communications medium 144 may be, for example, wire lines such as an Ethernet cable, fibre optic cable, and coaxial cable, and may be wireless.

The network testing system 110 and the network cards 120 may support one or more well known higher level communications standards or protocols such as, for example, one or more versions of the User Datagram Protocol (UDP), Transmission Control Protocol (TCP), Internet Protocol (IP), Internet Control Message Protocol (ICMP), Internet Group Management Protocol (IGMP), Session Initiation Protocol (SIP), Hypertext Transfer Protocol (HTTP), address resolution protocol (ARP), reverse address resolution protocol (RARP), file transfer protocol (FTP), Simple Mail Transfer Protocol (SMTP); may support one or more well known lower level communications standards or protocols such as, for example, the 10 and/or 40 Gigabit Ethernet standards, the Fibre Channel standards, one or more varieties of the IEEE 802 Ethernet standards, Asynchronous Transfer Mode (ATM), X.25, Integrated Services Digital Network (ISDN), token ring, frame relay, Point to Point Protocol (PPP), Fiber Distributed Data Interface (FDDI), Universal Serial Bus (USB), IEEE 1394 (also known as i.link® and Firewire®); may support proprietary protocols; and may support other protocols. Each network card 120 may support a single communications protocol, may support a number of related protocols, or may support a number or combination of unrelated protocols.

The term “network card” as used herein encompasses line cards, test cards, analysis cards, network line cards, load modules, interface cards, network interface cards, data interface cards, packet engine cards, service cards, smart cards, switch cards, relay access cards, CPU cards, port cards, and others. The network cards 120 may be referred to as blades, particularly when a processor is included on the network card.

The network cards 120 may include one or more processors 124, memory 126 such as a version of random access memory (RAM), and one or more network communications units 128. In another embodiment, the network cards 120 may have no processors 124 and may include one or more network communications units 128. In the embodiment in which the network cards do not include a processor, processing may be performed by a processor on a motherboard coupled with back plane 112, on another card, on the backplane or by a remote or external unit that includes a processor. When the network card 120 includes two or more network communications units 128, the network card 120 is in effect two or more network capable devices. That is, a network card 120 having n network communications units 128 may function as n network capable devices.

The network communications unit 128 may be implemented as one or more field programmable gate arrays (FPGAs), application specific integrated circuits (ASICs), programmable logic devices (PLDs), programmable logic arrays (PLAs), other kinds of devices, and combinations of these. The variable location of test information in a data unit described herein may be implemented in the network communications unit 128. The network communications unit 128 may support one or more communications protocols in hardware. The network communications unit 128 may include a network interface through which the network card 120 may transmit and/or receive communications over the network 140 to and from network capable devices 130.

The back plane 112 may serve as a bus or communications medium for the network cards 120. The back plane 112 may also provide power to the network cards 120.

The network testing system 110 may have coupled therewith a display 118 and user input devices such as a keyboard 114 and a mouse 116, as well as other user input devices including, for example, pens and trackballs. The user input devices may be coupled to a network card, other card, motherboard, or backplane included in the chassis. The network testing system 110 may have a computer (not shown) coupled thereto. The computer may be local to or remote from the network testing system 110. In another embodiment, the network testing system 110 may include a processor on a card, motherboard or backplane that allows the chassis to also serve as a computer workstation.

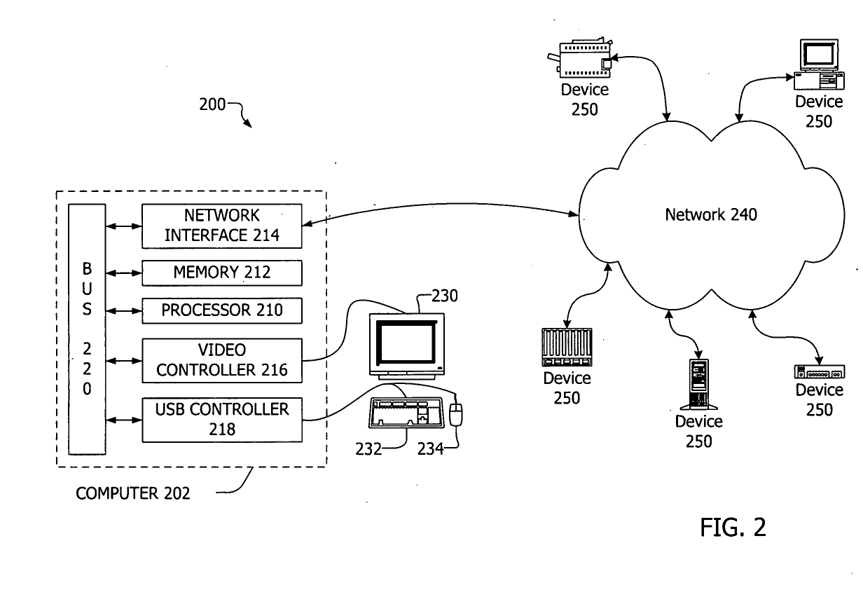

In addition to the chassis shown as the network testing system 110, the network testing system may be implemented in a computer such as a personal computer, server, or workstation as described below regarding FIG. 2. The network testing system 110 may be used alone or in conjunction with one or more other network testing systems 110. The network testing system 110 may be located physically adjacent to and/or remote to the network capable devices 130 in the network 140.

The network 140 may be a local area network (LAN), a wide area network (WAN), a storage area network (SAN), or a combination of these. The network 140 may be wired, wireless, or a combination of these. The network 140 may include or be the Internet. The network 140 may be public or private, may be a segregated test network, and may be a combination of these. The network 140 may be comprised of a single or numerous nodes providing numerous physical and logical paths for data units to travel. Each node may be a network capable device as described below.

Communications on the network 140 may take various forms, including frames, cells, datagrams, packets, higher level logical groupings, or other units of information, all of which are referred to herein as data units. Those data units that are communicated over a network are referred to herein as network traffic. The network traffic may include data units that represent electronic mail messages, text messages, streaming media such as music (audio) and video (movies, television, videophone), telephone (voice) conversations, web pages, graphics, documents, secure business transactions, and others. The data units may vary in size.

The term network capable device 130 as used herein means a device capable of communicating over the network 140 and/or listening to, relaying injecting, delaying, dropping, and/or modifying network traffic on network 140. The network capable devices 130 may be computing devices such as computer workstations, personal computers, servers, portable computers, set-top boxes, video game systems, personal video recorders, telephones, personal digital assistants (PDAs), computing tablets, and the like; peripheral devices such as printers, scanners, facsimile machines and the like; network capable storage devices including disk drives such as network attached storage (NAS) and SAN devices; network testing equipment such as analyzing devices, network conformance systems, emulation systems, network monitoring devices, and network traffic generators; components such as processors, network cards and network communications units; and networking devices such as routers, relays, firewalls, hubs, switches, bridges, traffic accelerators, load balancers, and multiplexers. In addition, the network capable devices 130 may include appliances such as refrigerators, washing machines, and the like as well as residential or commercial heating, ventilation, and air conditioning (HVAC) systems, alarm systems, and other devices or systems capable of communicating over a network. One or more of the network capable devices 130 may be devices to be tested and may be referred to as devices under test.

FIG. 2 is a block diagram of an environment 200 in which data units having test information located in varying positions may be sent and/or received by a network interface included in a computer. The computer 202 may be coupled with network 240 and may communicate with network capable devices 250. The computer 202 may be any computing device, and may be, for example, a personal computer or a server computer. The computer 202 includes processor 210 memory 212, network interface 214, video controller 216 and USB controller 218 all coupled with bus 220. Although depicted as a single bus, bus 220 may be one or more buses. The processor 210 may be general purpose computer processor or microprocessor such as, for example, the Pentium® line of processors manufactured by Intel Corporation of Santa Clara, Calif. The memory 212 may be RAM. Optionally, user input may be received via USB controller 218 to which user input devices, such as keyboard 232, mouse 234, trackball (not shown), pen and tablet (not shown), etc., are connected. Optionally, graphics, images, and text may be presented to a user by video controller 216 to which display 230 is coupled.

Network interface 214 is similar to and performs the same or similar functionality of network communications units 128 shown in FIG. 1. Network interface 214 provides support for the lower and/or higher communications protocols and standards described above. Network interface 214 allows the computer 202 to communicate over network 240. Network 240 is the same as or is similar to network 140.

Network interface 214 may be implemented as a chip or chipset on a motherboard or main board of a computer or other computing device, may be implemented as a chip or chip set on a network interface card (NIC) coupled to or included in a computer or computing device, and may otherwise communicate with, have access to, and/or be accessible to processor 210 and memory 212.

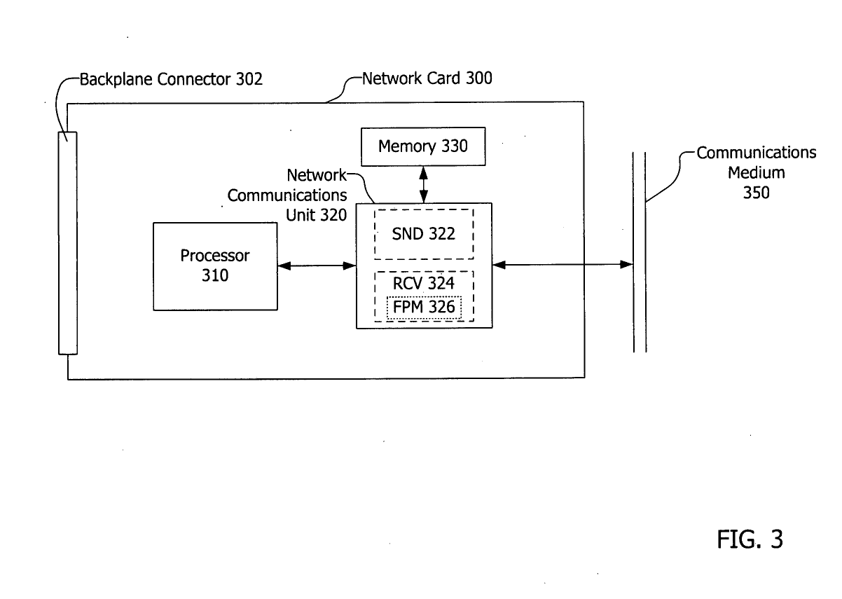

FIG. 3 is a block diagram of a network card in which data units having test information located in varying positions may be sent and/or received. The network card 300 may include hardware, software, firmware, and/or a combination thereof. The network card may include a processor 310, a network communications unit 320, a memory unit 330, and a backplane connector 302. The network card 300 may include other components and connectors, not shown. In another embodiment, there are no processors 310 in the network card 300. The network card 300 may have one or more network communications units 320. The network card 300 may also have one or more memory units 330 and one or more processors 310 included thereon. The network card 300 may include an operating system such as, for example, Linux or Unix, or a real-time operating system. The network card 300 may be coupled with a communications medium 350. The communications medium 350 may be a wire such as Ethernet cabling, coaxial cable, fibre optic cable, and others, and may be wireless.

The backplane connector 302 may allow the network card 300 to be coupled with a network testing system such as network testing system 110. The memory 330 may be, for example, RAM, and may be coupled with processor 310. The processor 310 may be a multipurpose processor, such as, for example, a PowerPC processor available from IBM, Inc., and may be a specialized processor. The processor 310 may be coupled with the network communications unit 320. The processor is capable of executing instructions which may be located in a local memory, other storage medium, or other local or remote storage device. In one embodiment, the network card 300 includes no processor, and commands are received from a processor included on another card, on a mother board, or on a backplane.

The network card 300 may include and/or have access to local and/or remote memory, storage media and storage devices. Instructions to be executed by the processor may be stored on and executed from any local or remote machine readable medium or storage device. A machine readable medium includes, for example, without limitation, magnetic media (e.g., hard disks, tape, floppy disks), optical media (e.g., CD, DVD), flash memory products (e.g., memory stick, compact flash and others), and volatile and non-volatile silicon memory products (e.g., random access memory (RAM), programmable read-only memory (PROM), electronically erasable programmable read-only memory (EEPROM), and others). A storage device is a device that allows for the reading from and/or writing to a machine readable medium. Storage devices include hard disk drives, DVD drives, flash memory devices, and others.

The network communications unit 320 may include one or more circuits, chips, logic, firmware and/or instructions that allow for communication of data units over a network and the sending and receiving of outgoing and incoming data units that have test information in a varying location. The network communications unit 320 may provide support for the lower and/or higher level communications standards or protocols described above. The network communications unit 320 may be implemented as one or more FPGAs. The network communications unit 320 may include or be coupled with a general purpose processor 310, memory 330 such as RAM, and other devices or components on network card 300. The network communications unit 320 may also be implemented or included on one or more ASICs, PLDs, PLAs, silicon devices, integrated circuits, general purpose processors, specialized processors such as a network processor, or other devices.

The network communications unit 320 may include a send processing unit (SND) 322 and a receive processing unit (RCV) 324. The receive processing unit 324 may include a floating pattern match unit (FPM) 326. The send processing unit 322 prepares data units for transmission on the communications medium 350 according to a communications protocol and pursuant to instructions or information received from either processor 310, an application running on a network testing system in which network card 300 is included, or from another software or hardware entity. The data units may be directed to a port in a network testing system, may traverse a network or network portion, and/or may pass through or be processed by one or more network capable devices. The data units may be directed to one or more network capable devices.

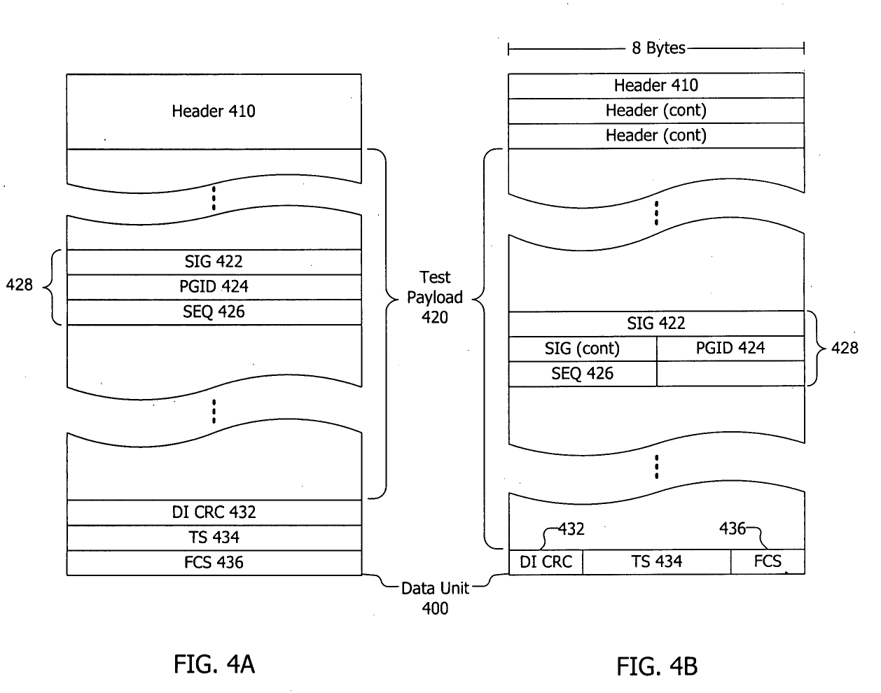

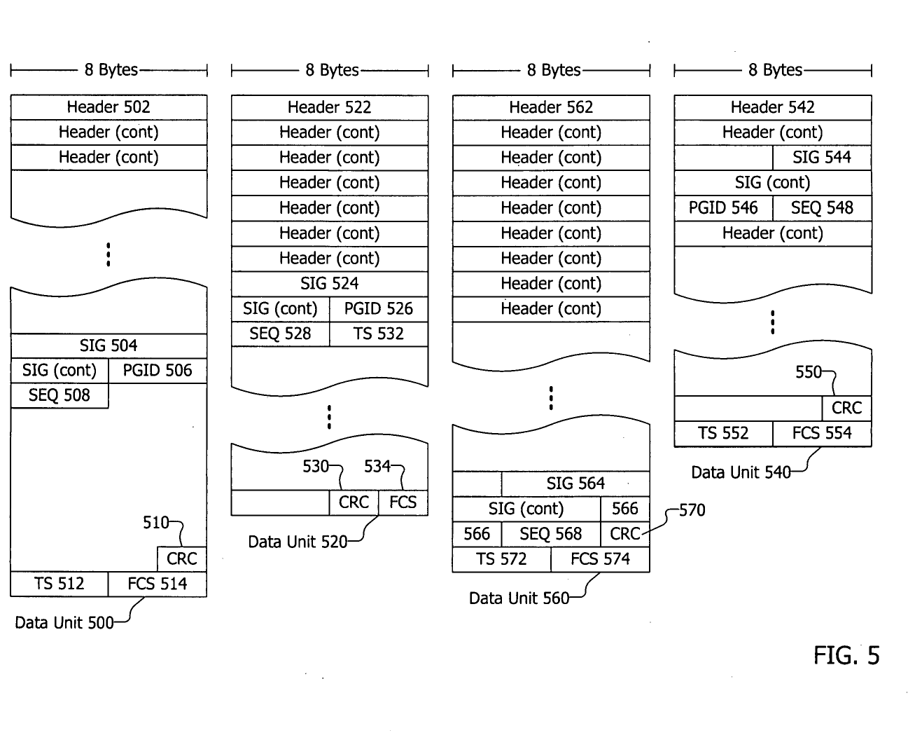

When preparing the data units for transmission, the send processing unit 322 adds, places or otherwise includes test information in the data unit. The test information may include a signature, a group identifier a sequence number, and/or other information about the data unit. The test information may also be referred to as a test information block. The contents of the data unit are described in more detail below regarding FIGS. 4A, 4B and 5.

The receive processing unit 324 receives data units from the communications medium 350 and extracts test information, data, and other information from the incoming data units. The floating pattern match unit 326 in the receive processing unit 324 may search for a signature included in the incoming data units. This search may be performed one bit at a time, in byte-size portions (8 bits), in word portions (16, 32, 48, 64, etc. bits), and the like. Different portions of the signature may be sought out simultaneously. The signature may be a constant size that is used consistently by network cards in network testing units. The signature may be, for example, 4 bytes, 8 bytes, 12 bytes, 16 bytes, etc. The signature may be a varying size.

Additional and fewer units, hardware and firmware may be included in the network card 300. In addition, send processing unit 322 and the receive processing unit 324 of the network communications unit 320 may be combined as a single entity or further refined into additional processing units, so long as the processing described herein is can be achieved.

Referring now to FIGS. 1, 2 and 3, computer instructions in the form of higher level software programs, object code, assembly language code, JAVA applets, or other instructions may be communicated to and stored on a storage device which may be coupled locally or may be accessible via electrical, optical, wireless, acoustic, and other means from a remote source, including via a network. These instructions may be executed to install, replace or upgrade the instructions stored on the network communications unit 128 and 320 and the network interface 214. These instructions may be executed only once, or may be executed each and every time the network testing system 110, computer 202 or other computing device is powered up, started or restarted.

Data Units

FIGS. 4A and 4B are block diagrams of a data unit having test information located in varying positions. The same data unit is shown in FIGS. 4A and 4B. FIG. 4A shows some of the contents of the data unit 400 conceptually without regard to size of the fields. FIG. 4B shows a proportionate mapping of the some of the contents of the data unit 400. Regarding the data units shown in FIGS. 4A, 4B and 5, the beginning of the data units is located at the upper left and the end of the data unit is located at the bottom right.

As required by various communications standards, data unit 400 begins with a header 410 and ends with a frame check sequence (FCS) 436 of two or four bytes. The header 410 may have various sizes which may depend on the particular communications standard, and may be of varying size.

The data unit 400 includes test information 428 which is located at a variable position within the data unit 400. That is, the location of the test information 428 in the data unit 400 may vary between data units in different flows or streams, or emanating from different nodes or ports. In one embodiment, the test information is at a uniform or constant location per flow or stream. In one embodiment, the test information is at a uniform or constant location per port or node.

Test information 428 refers to a signature (SIG) 422, a packet group identifier (PGID) 424, and a sequence number (SEQ) 426. The test information 428 may also include other data items, information or fields to convey test related information and data. The test information may include a timestamp, such as a send or transmit timestamp. The test information may be thought of and referred to as a test information block.

In this example, the signature may be 4 bytes, 8 bytes, 12 bytes, 16 bytes, etc. The signature is used to identify where the test information block is located in the data unit 400. In addition, a mask of only a certain pre-determined number of bits of an expected signature may be used to identify and locate the test information block within the data unit 400. In one embodiment the signature is 12 bytes long, as shown in FIG. 4B. The mask may refer to n bits of the signature, where n is a relatively small number such as, for example, 8, to where n is a relatively large number such as, for example, 90. For example, a 16 bit mask may be used to seek a signature with 16 specified bits set in an expected or known way. For example, a 12 byte signature may have a mask with bits 2, 3, 7, 12, 16, 21, 22, 23, 26, 32, 37, 43, 44, 53, 59 and 62 set to 1 or “care” and all other bits set to don't care.” Logic or instructions included in a network communications unit determines the location, size and values of the signature and any mask used, as well as the location of the signature and the location of the test information within a data unit.

The packet sequence group identifier 424 may identify a stream or flow within a stream, such that all data units in the stream or flow have the same packet group identifier 424. A flow is a group of data units sent in sequence from a particular node or port. The packet group identifier 424 may be a 2 byte, 4 byte, 8 byte or other size field. In one embodiment the packet group identifier 424 is 4 bytes long, as shown in FIG. 4B. Logic or instructions included in a network communications unit determines the value of the packet sequence group identifier 424.

The sequence number 426 identifies the ordering of data units within a stream or flow. The sequence number is typically sequentially assigned, such that when a series of data units are sent, the sequence number is incremented from data unit to data unit. The sequence number 426 may be a 2 byte, 4 byte, 8 byte or other size field. In one embodiment the sequence number 426 is 4 bytes long, as shown in FIG. 4B. Logic or instructions included in a network communications unit determines the value of the sequence number 426.

When a data unit is constructed, the network testing system may compute and place a data integrity cyclical redundancy check (DI CRC) 432 value toward the end of the data unit 400. In one embodiment the data integrity cyclical redundancy check 432 is a field 12 bytes from the end of the data unit 400. The data integrity cyclical redundancy check 432 value is computed to verify the contents of the test payload 420 of the data unit 420. The test payload of a data unit is that portion of the data unit spanning from the end of the header 410 to the beginning of the data integrity cyclical redundancy check 432 field. The data integrity cyclical redundancy check 432 value may be computed, for example, by the send processing unit 322 of network communications unit 320 shown in FIG. 3 and then placed into the data unit 400. Upon receipt of a data unit by a network card 300, the data integrity cyclical redundancy check value may recalculated and compared to the value in the data integrity cyclical redundancy check field 432 for accuracy by the receive processing unit 324 of network communications unit 320 shown in FIG. 3. The CRC calculations may be made according to techniques known to those skilled in the art. In other embodiments, other kinds of verification information may be used in addition to or in place of the data integrity cyclical redundancy check value.

A transmit or send timestamp 434 may be included in the data unit 400 toward the end of the data unit 400 next to the data integrity cyclical redundancy check field 432. In other embodiments, the send timestamp may be placed in the header of the 410, the test payload, and in the test information block 428. The send timestamp may be set as close as practicable to the time a network communications unit completes construction of a data unit and transmits the data unit onto a communications medium. The send timestamp 434 may be a 2 byte, 4 byte, 8 byte or other size field. In one embodiment, the send timestamp 434 is 4 bytes long, as shown in FIG. 4B.

FIG. 5 is a block diagram of data units having test information located in varying positions. The four example data units 500, 520, 540 and 560 show a variety of locations where test information may be included in a data unit. The test information may be included anywhere in a test payload such as, for example, toward the middle of a test payload; at the beginning of a test payload such that the test information is adjacent to a data unit header; at the end of the test payload such that the test information is adjacent to integrity and checksum fields at the end of the data unit; and may even be included in a data unit header, in certain circumstances. Although the data units in FIG. 5 and FIG. 4B are shown with an 8 byte scale, this scale in no way limits the data units. The 8 byte scale is only provided for convenience of reference.

Data unit 500 is an example data unit constructed with test information placed toward the middle of the data unit 500. The test information is between header 502 and the data integrity cyclical redundancy check 510. The test information includes a signature 504, a packet group identifier 506 and a sequence number 508. The data integrity cyclical redundancy check 510 is located adjacent to a timestamp 512 which is adjacent to the last field in the data unit, a frame check sequence 514.

Data unit 520 is an example data unit constructed with test information placed next to header 522. Header 522 is a relatively long header. The test information is relatively far from the data integrity cyclical redundancy check 530 and the end of the data unit. The test information includes a signature 524, a packet group identifier 526, a sequence number 528, and a timestamp 532. In this example data unit, the timestamp 532 is not toward the end of the data unit, but is included in the test information. In this example data unit, the signature 524 is immediately adjacent to or next to the header 522. The data integrity cyclical redundancy check 510 is located adjacent to the last field in the data unit, a frame check sequence 534. In this example, the frame check sequence 534 is two bytes long.

Data unit 540 is an example data unit constructed with test information placed in a large or long header 542 of the data unit. The test information is included before the test payload. The test information includes a signature 544, a packet group identifier 546 and a sequence number 548. In this example, the test information and the signature 544 do not begin on an 8 byte boundary, but begin but begin offset 4 bytes from an 8 byte boundary. The data integrity cyclical redundancy check 550 is located adjacent to a timestamp 552 which is adjacent to the last field in the data unit, a frame check sequence 554.

Data unit 560 is an example data unit constructed with test information placed next to the data integrity cyclical redundancy check 570 toward the end of the data unit and at the end of the test payload. Header 562 is a relatively long header. The test information is relatively far from the header 562 and the beginning of the data unit 560. The test information includes a signature 564, a packet group identifier 566, and a sequence number 568. In this example, the test information and, more specifically, the signature 564 do not begin on an 8 byte boundary, but begin offset 2 bytes from an 8 byte boundary. In this example data unit, test information and, more specifically, the sequence number 568 is immediately adjacent to or next to the data integrity cyclical redundancy check 570. The data integrity cyclical redundancy check 570 is located adjacent to a timestamp 572 which is adjacent to the last field in the data unit, a frame check sequence 574.

Methods

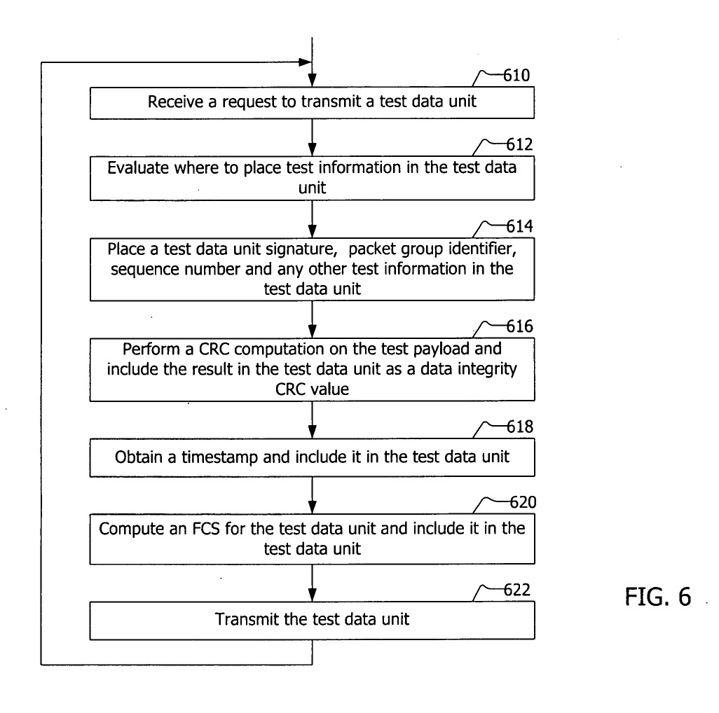

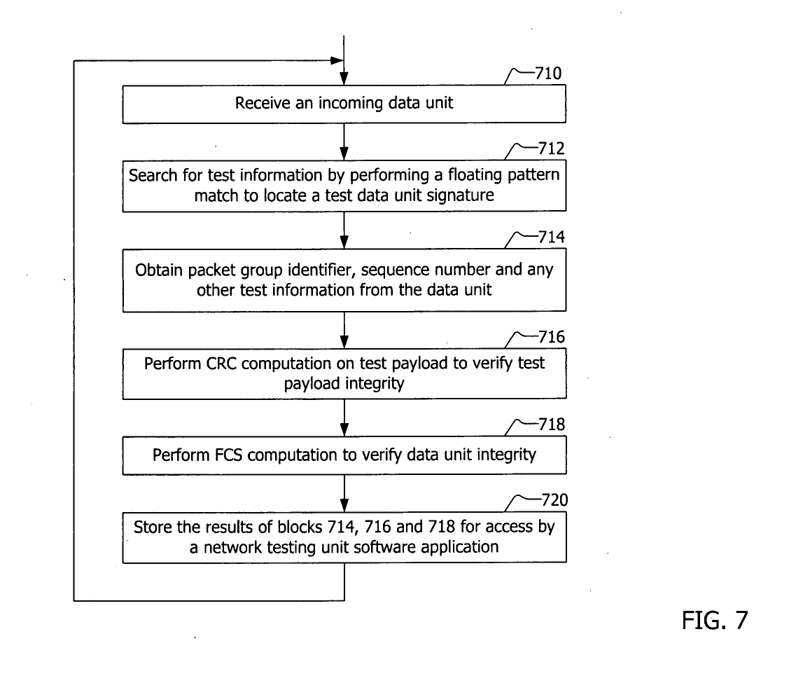

The methods described below in FIGS. 6 and 7 may be implemented by network communications units 128 and 320 of network cards 120 and 300 and network interface 214 in a network testing system 110 and computer 202, as shown in FIGS. 1, 2 and 3, as well as in other computing devices.

FIG. 6 is a flow chart of a method performed when preparing to send data units having test information located in varying positions. FIG. 7 is a flow chart of a method performed when receiving data units having test information located in varying positions. The functionality described regarding FIGS. 6 and 7 may be performed by a network communications unit 128 and 320 and a network interface 214 described above regarding FIGS. 1, 2 and 3.

As shown in FIG. 6, a request to transmit an outgoing data unit is received, as shown in block 610. Where to place test information in the test data unit is evaluated, as shown in block 612. The location is determined by logic and/or instructions in a network communications unit. The location may be system defined and, in one embodiment, may be user configurable. A test data unit signature, a packet group identifier, and a sequence number are placed in the evaluated location in the test data unit, as shown in block 614. Other test information may also be included in the test information, such as, for example, a timestamp. A CRC computation is performed on the test payload and the result is included in the test data unit as a data integrity CRC value, as shown in block 616. A timestamp is obtained and included in the test data unit, as shown in block 618. An FCS is computed for the test data unit according to a particular communication standard and included in the test data unit, as shown in block 620. The result is a test data unit like the data units 400, 500, 520, 540 and 560 shown in FIGS. 4A, 4B and 5. The test data unit is then transmitted, as shown in block 622. Information about the test data unit and the transmission of the test data unit may be stored for use in evaluating a network device, a network segment, a network application or other network component when the transmitted data unit is received.

As shown in FIG. 7, an incoming data unit is received, as shown in block 710. Upon receipt, a receive timestamp may be stored in the data unit or with information stored regarding the data unit. Upon or during receipt of the data unit, a search is made for test information by performing a floating pattern match to locate a test data unit signature, as shown in block 712. A known signature is searched for within the incoming data unit. The signature may vary between data units in particular streams or flows emanating from particular nodes or ports. In one embodiment, a search is performed to locate an expected signature based on only those bits of the signature designated by a bit mask. A floating pattern matcher 326 described above regarding FIG. 3 may be used to perform the search for a test data unit signature.

A packet group identifier, a sequence number and other test information is obtained from the test information area in the data unit, as shown in block 714. A timestamp, the send timestamp, may also be obtained from the data unit. In various embodiments, the timestamp may be obtained from the test information block, or from another location in the data unit, such is in the header or toward the end of the data unit. If a signature is not found, the test information is not obtained from the data unit and block 714 is skipped.

A CRC computation is performed on the test payload to verify the integrity of the test payload, as shown in block 716. A computation of the FCS is performed to verify the integrity of the data unit, as shown in block 718.

The results of blocks 714, 716 and 718 are stored in memory for access by a network testing unit software application, as shown in block 720. In another embodiment the results of blocks 714, 716 and 718 are communicated to a network testing unit software application. The results of blocks 714, 716 and 718 may be stored on a machine readable medium included in, coupled with or otherwise accessible by a network testing system. If a signature is not found in a data unit, the results of blocks 716 and 718 are stored.

The test information accumulated concerning a number of data units received, such as from a flow or stream, may be used by a network testing system to evaluate whether any data units were missing, whether the data units were received in order, and to perform various analyses. The test information accumulated concerning a number of data units received may be used to prepare various statistics, including for example, the number of bytes received in a flow or stream; the number of data units received in a flow or stream; the receive rate for a flow or stream; sequence error analysis and statistics; order information analysis and statistics; various latency data may be computing using the timestamp include in the data unit and a receive timestamp that may be obtained upon receipt of the data unit, including maximum data unit latency, minimum data unit latency, cumulative data unit latency, and average data unit latency; and others.

With regard to FIGS. 6 and 7, additional and fewer steps may be taken, the steps may be performed concurrently or in an order different from that shown, and the steps as shown may be combined or further refined to achieve the methods described herein.

Although exemplary embodiments of the invention have been shown and described, it will be apparent to those having ordinary skill in the art that a number of changes, modifications, or alterations to the invention as described herein may be made, none of which depart from the scope of the invention. All such changes, modifications and alterations should therefore be seen as within the scope of the invention.

1. A method for preparing a data unit comprising:
determining a location in the data unit where test information will be placed, the test information including at least a signature to identify where the test information is located, a packet group identifier and a sequence number;
placing the test information in the data unit at the location;
computing a cyclical redundancy check value for a test payload;
placing cyclical redundancy check value toward an end of the data unit;
obtaining a timestamp;
placing the timestamp in the data unit;
computing a frame check sequence value for the data unit;
placing the frame check sequence value at the end of the data unit.

2. The method of claim 1 wherein the location is in a header of the data unit.

3. The method of claim 1 wherein the location is between a header of the data unit and the frame check sequence.

4. The method of claim 1 wherein the location varies between flows of data units.

5. The method of claim 1 wherein the timestamp is placed toward the end of the data unit.

6. The method of claim 1 wherein the timestamp is placed in a header of the data unit.

7. The method of claim 1 wherein the timestamp is placed with the test information.

8. A hardware device configured to handle network communications and to perform actions comprising:
determining a location in a data unit where test information will be placed, the test information including at least a signature to identify where the test information is located, a packet group identifier and a sequence number;
placing the test information in the data unit at the location;
computing a cyclical redundancy check value for a test payload;
placing cyclical redundancy check value toward an end of the data unit;
obtaining a timestamp;
placing the timestamp in the data unit;
computing a frame check sequence value for the data unit;
placing the frame check sequence value at the end of the data unit.

9. The hardware device of claim 8 wherein the location is in a header of the data unit.

10. The hardware device of claim 8 wherein the location is between a header of the data unit and the frame check sequence.

11. The hardware device of claim 8 wherein the location varies between flows of data units.

12. The hardware device of claim 8 wherein the timestamp is placed toward the end of the data unit.

13. The hardware device of claim 8 wherein the timestamp is placed in a header of the data unit.

14. The hardware device of claim 8 wherein the timestamp is placed with the test information.

15. A network card having the hardware device of claim hardware device of claim 8 included thereon.

16. A network testing system having at least one network card of claim 15 included thereon.

17. A computer having at least one of the network cards of claim 15 included therewith.
